(19) United States
(12) Patent Application Publication
(10) Pub. No.: US 2013/0140724 A1
(43) Pub. Date: Jun. 6, 2013

(54) METHOD OF DETERMINING MANUFACTURING CONDITION OF EYEGLASS LENS AND METHOD OF MANUFACTURING EYEGLASS LENS

(71) Applicants: Hoya Corporation, Tokyo (JP); Hoya Lens Thailand Ltd., Patumthani (TH)

(72) Inventors: Nobuyuki TADOKORO, Tokyo (JP); Anutasara SUKBUMPENG, Patumthani (TH)

(73) Assignees: HOYA LENS THAILAND LTD., Patumthani (TH); HOYA CORPORATION, Tokyo (JP)

(21) Appl. No.: 13/661,460

(22) Filed: Oct. 26, 2012

(30) Foreign Application Priority Data
Oct. 28, 2011 (JP) 2011-237615
Oct. 24, 2012 (JP) 2012-234739

(51) Int. Cl. B29D 11/00

(52) U.S. Cl. CPC B29D 11/0098
USPC 264/1.38

(57) ABSTRACT

An aspect of the present invention relates to a method of determining a manufacturing condition of a polythiourethane eyeglass lens obtained via a process of obtaining polythiourethane by polymerization reaction of an iso(thio)cyanate compound and a thiol compound, comprising determining a candidate composition for a starting material mixture and a candidate polymerization reaction condition employed in the polymerization reaction in actual manufacturing; polymerizing the starting material mixture of the candidate composition that has been determined under the candidate polymerization reaction condition to obtain a test sample; testing the obtained test sample by irradiation with a xenon lamp to determine whether or not change into red-like color is present following irradiation with the xenon lamp; and determining a starting material mixture composition and a polymerization reaction condition to be employed in the polymerization reaction in actual manufacturing with the use of a result of the determination as an indicator.

### CROSS-REFERENCE TO RELATED APPLICATIONS

This application claims the benefit of priority under 35 USC 119 to Japanese Patent Application No. 2011-237615 filed on Oct. 28, 2011 and Japanese Patent Application No. 2012-234739 filed on Oct. 24, 2012, which are expressly incorporated herein by reference in their entirety.

### BACKGROUND OF THE INVENTION

1. Field of the Invention

The present invention relates to a method of determining a manufacturing condition of an eyeglass lens, and more particularly, to a method of determining a condition in manufacturing a polythiourethane eyeglass lens capable of providing a polythiourethane eyeglass lens that does not change into red-like color over time.

The present invention further relates to a method of manufacturing an eyeglass lens permitting the manufacturing of a polythiourethane eyeglass lens of high quality that can be maintained for an extended period by adopting the manufacturing condition determined by the above method.

### DISCUSSION OF THE BACKGROUND

Generally, eyeglass lenses are manufactured by forming various functional films such as a hardcoat film and an antireflective film on a lens substrate. A plastic lens or a glass lens can be used as the lens substrate. Today, many eyeglass lenses are manufactured with lens substrates in the form of plastic lenses. That is because plastic lenses afford the advantages of being lighter in weight and less prone to cracking. than glass lenses.

The thickness of an eyeglass lens is affected by the refractive index of the lens substrate. The higher the refractive index nd of the plastic lens employed as the lens substrate, the thinner the eyeglass lens can be made. Accordingly, the development of plastic lens materials in the form of high refractive index materials is advancing. A variety of high refractive index plastic materials have been proposed and put to practical use thus far. Among these, polythiourethane plastic lenses obtained by polymerizing an iso(thio)cyanate compound with a thiol compound (for example, see Japanese Examined Patent Publication (KOKOKU) Heisei Nos. 6-5323 and 7-5585 or English language family members U.S. Pat. No. 5,326,501 and U.S. Pat. No. 5,403,938, which are expressly incorporated herein by reference in their entirety) have high refractive indexes of about nd=1.6 and are thus widely employed as lens substrates in thin eyeglass lenses.

Examples of properties that are demanded of eyeglass lenses are that they not undergo a decrease in quality such as change in color over time to maintain high quality for an extended period. Accordingly, in the field of manufacturing eyeglass lenses, to stably provide eyeglass lenses that do not undergo a decrease in quality over time, accelerated durability tests are conducted on test samples that have been produced under candidate manufacturing conditions to determine the manufacturing conditions to be used in actual manufacturing. Manufacturing conditions identical or similar to the manufacturing conditions of test samples that exhibit good test results are then normally adopted in actual manufacturing. Conventionally, an accelerated durability test in the form of heat resistance evaluation by heating in an over or evaluation by a QUV promoting weatherability test (also referred to as a “QUV” test, hereinafter) are employed. An eyeglass lens that has been manufactured under manufacturing conditions identical or similar to those of a test sample that does not exhibit a drop in quality such as change in color following oven heating or a QUV test is thought to be able to exhibit excellent durability without undergoing deterioration over an extended period, even in actual use.

However, in recent years, it has been revealed that polythiourethane eyeglass lenses in which the maintaining of good quality over extended periods has been guaranteed by an accelerated durability test undergo a drop in quality in the form of change into red-like color (for example, pink to red) of the entire lens with long-term use. That is, it has been found impossible to avoid the shipping of product lenses in the form of polythiourethane eyeglass lenses that undergo change into red-color with long-term use even by conducting the accelerated durability test that has conventionally been employed.

### SUMMARY OF THE INVENTION

An aspect of the present invention provides for a means of obtaining a polythiourethane eyeglass lens that is capable of maintaining high quality without undergoing change into red-like color over extended periods.

The above-mentioned QUV test is a weatherability test in which a test sample is subjected to repeated cycles of UV irradiation and exposure to dew condensation. Deterioration of the test sample is promoted by UV irradiation at high temperature and dew condensation in the dark. UV radiation is employed for irradiation in QUV testing because, among the various wavelengths of light contained in the natural light to which a product is exposed during actual use, UV radiation, which is short wavelength light with a high energy level, is thought to be the main cause of the drop in quality.

The present inventors conducted extensive research in this regard, resulting in the discovery that a polythiourethane eyeglass lens that had been manufactured under manufacturing conditions identical or similar to those of a polythiourethane sample undergoing change into red-like color following irradiation with a xenon lamp underwent change into red-like color in the course of actual long-term use. The mechanism was not necessarily clear. However, based on this new discovery and facts demonstrated in Examples set forth further below, the present inventors presumed a mechanism such that, in a polythiourethane eyeglass lens, light of wavelengths falling within the range of natural light caused unreacted iso(thio)cyanate compounds to undergo some sort of reaction, thereby causing change into red-like color, as described above. Accordingly, it was thought that this color change could not be reproduced in an accelerated durability test by irradiation with light of a short wavelength in the form of ultraviolet radiation, and that only irradiation with a light source having a continuous spectrum approaching that of sunlight in the form of a xenon lamp would be able to reproduce it.

The present invention was devised based on the above knowledge.

An aspect of the present invention relates to a method of determining a manufacturing condition of a polythiourethane eyeglass lens obtained via a process of obtaining polythiourethane by polymerization reaction of an iso(thio)cyanate compound and a thiol compound, which comprises:

determining a candidate composition for a starting material mixture and a candidate polymerization reaction condition employed in the polymerization reaction in actual manufacturing;

polymerizing the starting material mixture of the candidate composition that has been determined under the candidate polymerization reaction condition to obtain a test sample;

testing the obtained test sample by irradiation with a xenon lamp to determine whether or not change into red-like color is present following irradiation with the xenon lamp; and

determining a starting material mixture composition and a polymerization reaction condition to be employed in the polymerization reaction in actual manufacturing with the use of a result of the determination as an indicator.

A further aspect of the present invention relates to a method of manufacturing a polythiourethane eyeglass lens, which comprises determining a manufacturing condition by the above method, and polymerizing polythiourethane under the manufacturing condition that has been determined.

The present invention can provide a polythiourethane eyeglass lens that does not undergo change into red-like color over extended periods and that maintains good quality.

Other exemplary embodiments and advantages of the present invention may be ascertained by reviewing the present disclosure.

### DETAILED DESCRIPTION OF THE EMBODIMENTS

Unless otherwise stated, a reference to a compound or component includes the compound or component by itself, as well as in combination with other compounds or components, such as mixtures of compounds.

As used herein, the singular forms “a,” “an,” and “the” include the plural reference unless the context clearly dictates otherwise.

Except where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range. For example, if a range is from about 1 to about 50, it is deemed to include, for example, 1, 7, 34, 46.1, 23.7, or any other value or range within the range.

The following preferred specific embodiments are, therefore, to be construed as merely illustrative, and non-limiting to the remainder of the disclosure in any way whatsoever. In this regard, no attempt is made to show structural details of the present invention in more detail than is necessary for fundamental understanding of the present invention; the description making apparent to those skilled in the art how several forms of the present invention may be embodied in practice.

The present invention relates to a method of determining a manufacturing condition of a polythiourethane eyeglass lens obtained via a process of obtaining polythiourethane by polymerization reaction of an iso(thio)cyanate compound and a thiol compound.

The method of determining a manufacturing condition of the present invention comprises:

determining a candidate composition for a starting material mixture and a candidate polymerization reaction condition employed in the polymerization reaction in actual manufacturing;

polymerizing the starting material mixture of the candidate composition that has been determined under the candidate polymerization reaction condition to obtain a test sample;

testing the obtained test sample by irradiation with a xenon lamp to determine whether or not change into red-like color is present following irradiation with the xenon lamp; and

determining a starting material mixture composition and a polymerization reaction condition to be employed in the polymerization reaction in actual manufacturing with the use of a result of the determination as an indicator.

Thus, as set forth above, the shipping of product lenses in the form of polythiourethane eyeglass lenses that undergo change into red-like color over time can be prevented in advance. In the present invention, the state of change into red-like color or exhibiting a red-like color can refer to a state of exhibiting a color tone such as red, pink, magenta, dark red, or orange by reflecting light with a wavelength of 590 to 750 nm (wavelength range of orange to red), more specifically 620 to 750 nm (red wavelength range). Having a wavelength with a transmittance of less than 90% at 450 to 570 nm, which is the wavelength range from blue, the complementary color to orange, to green, the complementary color to red, can also be referred to as a state of change into red-like color.

The method of determining a manufacturing condition of the present invention will be described in greater detail below.

In the present invention, the eyeglass lens for which the manufacturing condition is determined is a polythiourethane eyeglass lens. Polythiourethane is obtained by polymerization reaction of an iso(thio)cyanate compound and a thiol compound. Thus, the starting material mixture for obtaining a polythiourethane eyeglass lens contains at least an iso(thio)cyanate compound and a thiol compound. In the present invention, the term “iso(thio)cyanate” is used to mean isocyanates and isothiocyanates. The starting material mixture may contain various other components that are commonly employed in the synthesis of polythiourethane (such as copolymerizable monomers, polymerization initiators, and catalysts). For the various components contained in the starting material compound in the present invention, reference can be made to Japanese Examined Patent Publication (KOKOKU) Heisei Nos. 6-5323 and 7-5585, for example.

As set forth further below in Examples, the fact that the change into red-like color that occurs in a polythiourethane eyeglass lens employed for an extended period can be reproduced by irradiation with a xenon lamp was discovered by the present inventors. This change in color is thought to occur because of unreacted iso(thio)cyanate compound remaining following polymerization reaction. The change into red-like color that occurs in a polythiourethane eyeglass lens is primarily a phenomenon whereby a pink to red color appears throughout the lens. It is produced by an increase in the absorption of green light, which is complementary to pink, and blue to bluish-green light, which is complementary to red (causing the transmittance of such light to decrease). Examples of factors affecting the quantity of unreacted residual iso(thio)cyanate compound are:

(1) The presence of large quantities of iso(thio)cyanate compounds in the starting material mixture;
(2) The presence of a small quantity of thiol compound in the starting material mixture;
(3) Inadequate advancement of polymerization reaction due to the presence of small quantities of polymerization initiators or catalysts; and
(4) Inadequate advancement of polymerization reaction due to an inadequate temperature or period of polymerization reaction.

Accordingly, to obtain a polythiourethane eyeglass lens that can continuously maintain good quality without undergoing change into red-like color even with an extended period of use, it is desirable to conduct polymerization reaction of the polythiourethane under the manufacturing condition that does not produce a large quantity of unreacted iso(thio)cyanate due to factors (1) to (4) above. The present invention makes it easy to discover such manufacturing conditions through the steps given below without extensive trial and error.

First, candidate manufacturing conditions are determined for the manufacturing of a product eyeglass lens. Specifically, suitable components are obtained in the form of commercial products for the starting material components such as the iso(thio)cyanate compound and thiol compound employed in polymerization reaction of polythiourethane, or they are synthesized by known methods. Next, the blending ratio of these components is determined based on various characteristics required of the product eyeglass lens (such as the refractive index, hardness, and transmittance). In this manner, candidate compositions are determined for the starting material mixture. Subsequently, polymerization reaction conditions such as a temperature and period at which polymerization reaction of the candidate compositions can be suitably progressed are determined as candidate polymerization conditions.

Next, the starting material mixtures of the candidate compositions determined as set forth above are polymerized under the candidate polymerization reaction conditions to obtain test samples. Polyurethane eyeglass lenses are normally manufactured by cast polymerization in which a starting material mixture is polymerized in a forming mold having a lens-shaped cavity. However, the test samples do not necessarily have to be of the same lens shape as the product lens, and can be of any shape, such as plate-shaped or block-shaped.

The test samples obtained as set forth above are subjected to testing by irradiation with a xenon lamp. The xenon lamp is a lamp using light emitted by means of an electrical discharge in xenon gas, which is widely known. Based on the method of lighting the lamp, such lamps are divided into xenon arc lamps and xenon flash lamps. Xenon arc lamps are roughly divided into short arc lamps and long arc lamps based on the length (distance between electrodes) of the light-emitting element. The xenon lamps that are widely employed in various applications are short arc lamps. However, since all xenon lamps have a continuous spectrum close to that of sunlight, they are suitable for use in the xenon lamp irradiation test in the present invention. For example, the irradiation with a xenon lamp can be conducted by irradiation with a xenon lamp positioned above the test sample. The irradiation conditions are desirably set to reproduce the environment in which the product eyeglass lens will be placed. For example, the distance between the light source xenon lamp and the test sample can be made about 100 to 500 mm, a light level of about 100 to 500 W/m² (full wavelength range) can be employed, and the irradiation period can be made about 100 to 1,000 hours. When the test sample has a lens shape, the surface that is irradiated by the xenon lamp can be either of the principal surfaces or an edge surface. For plate-shaped test samples and test samples of other shapes, the surface that is irradiated is not specifically limited.

As is set forth in Examples further below, the fact that a polythiourethane eyeglass lens obtained under the manufacturing condition identical or similar to those of a test sample exhibiting red-like color (pink to red) following irradiation with a xenon lamp underwent change into red-like color in the same manner as the test sample following use for an extended period of one year or more, for example, was revealed by the results of extensive research conducted by the present inventors. Accordingly, by determining whether or not change into red-like color occurs in the test sample following irradiation with a xenon lamp, using the result of this determination as an indicator, and determining the polymerization reaction condition and the starting material mixture composition to be used in polymerization reaction to obtain a product lens in actual manufacturing, it is possible to provide a high-quality polythiourethane eyeglass lens that does not undergo change into red-like color even with long-term use. The above determination can be made visually, by conducting a known color tone test using Lab values or the like, or by determining change into red-like color based on the low transmittance of color wavelengths that are complementary to pink through red in the spectral transmission spectrum.

The method of determining a manufacturing condition for actually obtaining a polythiourethane eyeglass lens using the determination results as an indicator will be described next.

One embodiment of the determination method is for the polymerization reaction conditions and the starting material mixture composition of a test sample that has been determined not to change in color in a xenon lamp irradiation test to be employed as is as the manufacturing condition in actual manufacturing.

Another embodiment of the determination method is to determine the polymerization reaction condition and the starting material mixture composition to be employed in actual manufacturing based on the polymerization reaction condition and the starting material mixture composition of a test sample that has been determined not to change in color in a xenon lamp irradiation test. Specifically, the used quantities of additives thought to not affect change in color can be varied while maintaining the blending ratio of the iso(thio)cyanate compound and thiol compound that are thought to affect change in color.

Still another embodiment of the determination method is to determine the polymerization reaction condition and the starting material mixture composition used in polymerization reaction in actual manufacturing based on the polymerization reaction condition and the starting material mixture composition of a test sample that has been determined to change in color in a xenon lamp irradiation test. As set forth above, unreacted iso(thio)cyanate compounds are thought to cause change in color. Thus, it is desirable to vary the polymerization reaction condition and the starting material mixture composition of a test sample that has been determined to change in color so as to provide a polythiourethane eyeglass lens that does not undergo change into red-like color following use for an extended period. Specifically, in this regard, manufacturing conditions that are varied by decreasing the quantity of iso(thio)cyanate compound, increasing the quantity of thiol compound, and increasing the quantities of polymerization initiators and catalysts employed to promote polymerization reaction in the starting material mixture composition of a test sample that has been determined to change in color; raising the reaction temperature; and lengthening the reaction period are desirably employed as the manufacturing condition in actual manufacturing. The variation in polymerization reaction condition relates to changes in actual manufacturing steps and manufacturing equipment. Thus, for the starting material mixture composition of a test sample that has been determined to change in color, a composition in which the blending ratio of thiol compound relative to iso(thio)cyanate compound has been increased or a composition in which the blending ratio of iso(thio)cyanate compound relative to thiol compound has been reduced is preferably determined as a starting material mixture composition for use in actual manufacturing.

In the present invention as set forth above, the results of a determination made by a xenon lamp irradiation test are used as an indicator to determine the polymerization reaction condition and the starting material mixture composition for actual manufacturing to obtain a product polythiourethane eyeglass lens, thereby providing a product lens that does not change into red-like color even when employed for an extended period. In an eyeglass lens, it is preferable for deterioration in quality, such as cracking and the separation of functional films, not to occur with use for extended periods. Thus, in addition to the above xenon lamp irradiation test, it is desirable to subject the test sample to known accelerated durability tests such as oven heating and QUV tests, and to use the results of these tests as indicators to determine the polymerization reaction condition and the starting material mixture composition employed in the polymerization reaction of polythiourethane in actual manufacturing. The same sample as the test sample employed in xenon lamp irradiation testing, or another test sample obtained under the identical manufacturing condition, can be employed in the additional accelerated durability testing.

The present invention further provides a method of manufacturing a polythiourethane eyeglass lens, characterized by comprising: determining the manufacturing condition, that is, determining the polymerization condition and the starting material mixture composition of a polythiourethane eyeglass lens, by the method of determining a manufacturing condition of the present invention set forth above; and polymerizing polythiourethane under the manufacturing condition that has been determined.

As set forth above, and as disclosed in Examples further below, whether or not change into red-like color occurs following the xenon lamp irradiation test corresponds well to whether or not change in color will be present in the product lens following long-term use. Thus, manufacturing a product lens under the manufacturing condition determined so that change into red-like color will not occur based on the results of a xenon lamp irradiation test makes it possible to reliably provide a polythiourethane eyeglass lens that does not undergo a drop in quality due to change into red-like color, even with long-term use. Except for determining the manufacturing condition based on the method of determining a manufacturing condition of the present invention, known techniques can be employed without limitation in the method of manufacturing a polythiourethane eyeglass lens of the present invention. Following polymerization reaction, the polythiourethane eyeglass lens that is obtained is normally subjected to post-processing such as washing, grinding, and polishing to obtain a lens substrate that is subjected to processing steps such as the formation of functional films by known methods and then shipped as a product lens.

### EXAMPLES

The present invention will be described based on Examples below. However, the present invention is not limited to the embodiments shown in Examples.

1. Selection of Candidate Starting Material Mixture Compositions and Candidate Polymerization Reaction Conditions

Three polythiourethane eyeglass lenses (product name EYAS, made by Hoya: referred to as “lens 1,” “lens 2,” and “lens 3”, hereinafter) that had each been used for about one to two years by a user who wore glasses under identical or similar use environments were visually inspected. Lens 1 and lens 3 exhibited a pink coloration. However, such color was not observed in lens 2. All three lenses were concave on one side and convex on the other.

The manufacturing conditions of lenses 1 to 3 were investigated. The polymerization reaction conditions and types of starting material components were all found to be identical, but the starting material mixture employed in lens 1 contained more isocyanate compound than that employed in lens 2. Lens 3 had been manufactured using a starting material mixture containing less thiol compound than that employed in lens 2.

Based on the above results, the nine compositions shown in Table 1 were selected as starting material mixture compositions for test samples that were subjected to xenon lamp irradiation testing.

2. Preparation of Test Samples

Cast polymerization was conducted under polymerization conditions identical to those yielding lenses 1 and 2 above using a forming mold having a cavity that was capable of molding a lens having a concave-convex shape using the starting material mixtures of each of the nine compositions indicated in Table 1. The molded polythiourethane members of concave-convex shape that were obtained by cast polymerization were removed from the forming mold, yielding nine test samples.

3. Xenon Lamp Irradiation Testing

Each test sample was positioned on a test platform with the convex surface thereof facing vertically upward. Next, a commercial xenon short arc lamp positioned 254 mm vertically above the convex surface was used to irradiate light at a light quantity of 320 W/m² (full wavelength range) for 100 hours toward the convex surface of each test sample. After having been irradiated with light, each of the test samples was evaluated for the presence of pinkening by the following two methods.

### (1) Visual Observation

The test samples and above lenses 1 to 3 were visually observed and evaluated for the presence of pinkening. The results are given in Table 1.

### (2) Evaluation Based on Spectral Transmittance

A Hitachi U3410 spectrophotometer was employed to measure the spectral transmission spectrum at wavelengths of 380 nm to 780 nm on the convex surface side of each of the test samples and lenses 1 to 3 above. Based on the spectral transmission spectra obtained, the transmittance at 560 nm, which is the wavelength region of green light, the complementary color to pink, was measured. The results are given in Table 1. The greater the absorption of green light, which is the complementary color to pink, the lower the transmittance of such light. Thus, a low transmittance in the wavelength region of green light meant that pinkening had occurred.

TABLE 1

| | | Determination of | |
|---|---|---|---|
| | | presence or absence of pinkening | |
| | | by visual observation | Transmittance |
| | | (Presence of pinkening: x, | at a wavelength of 560 nm |
| Test | Starting material mixture | Presence of more pinkening than x: xx, | (less than 90 percent: x, |
| samples | composition | Absence of pinkening: ∘) | 90 percent or more: ∘) |
| Sample 1 | Starting material mixture | xx | x |
| | composition identical to that | | |
| | of lens 1 | | |
| Sample 2 | Reducing isocyanate | x | x |
| | compound in the starting | | |
| | material mixture | | |
| | composition of the above | | |
| | sample 1 | | |
| Sample 3 | Further reducing isocyanate | ∘ | ∘ |
| | compound in the starting | | |
| | material mixture | | |
| | composition of the | | |
| | above sample 2 | | |
| Sample 4 | Further reducing isocyanate | ∘ | ∘ |
| | compound in the starting | | |
| | material mixture | | |
| | composition of the above | | |
| | sample 3 | | |
| Sample 5 | Starting material mixture | ∘ | ∘ |
| | composition identical to that | | |
| | of lens 2 | | |
| | (containing less isocyanate | | |
| | compound than the above | | |
| | sample 4 but more thiol | | |
| | compound than the | | |
| | following sample 6) | | |
| Sample 6 | Further increasing thiol | ∘ | ∘ |
| | compound in the starting | | |
| | material mixture | | |
| | composition of the | | |
| | following sample 7 | | |
| Sample 7 | Further increasing thiol | ∘ | ∘ |
| | compound in the starting | | |
| | material mixture | | |
| | composition of the | | |
| | following sample 8 | | |
| Sample 8 | Increasing thiol compound | x | x |
| | in the starting material | | |
| | mixture composition of the | | |
| | following sample 9 | | |
| Sample 9 | Starting material mixture | xx | x |
| | composition identical to that | | |
| | of lens 3 | | |
| Lens 1 | — | xx | x |
| Lens 2 | — | ∘ | ∘ |
| Lens 3 | — | xx | x |

As indicated in Table 1, Samples 1 and 9, prepared under the same manufacturing conditions (starting material mixture composition and polymerization reaction conditions) as lenses 1 and 3 above, which had pinkened with long-term use, exhibited the identical or similar pinkening as lenses 1 and 3 following xenon lamp irradiation. Sample 5, prepared under the same manufacturing conditions as lens 2 above, which had not exhibited pinkening following long-term use, did not exhibit pinkening following xenon lamp irradiation. The above results demonstrate that the xenon lamp irradiation test was able to reproduce change into red-like color that occurred in polythiourethane eyeglass lenses following long-term use. Accordingly, it became possible to ship product lenses in the form of polythiourethane eyeglass lenses capable of maintaining good quality without undergoing pinkening over an extended period by employing the manufacturing conditions of samples 3 to 8 in Table 1, which did not exhibit pinkening following xenon lamp irradiation testing, in actual manufacturing.

The results of Table 1 indicate that the smaller the amount of thiol compound employed relative to isocyanate compound, and the greater the amount of isocyanate compound relative to thiol compound, the greater the pinkening that occurred. Based on these results, it was presumed that change into red-like color that occurs in the course of employing polythiourethane eyeglass lenses for extended periods is due to unreacted iso(thio)cyanate compound.

The present invention is useful in the field of manufacturing eyeglass lenses.

Although the present invention has been described in considerable detail with regard to certain versions thereof, other versions are possible, and alterations, permutations and equivalents of the version shown will become apparent to those skilled in the art upon a reading of the specification. Also, the various features of the versions herein can be combined in various ways to provide additional versions of the present invention. Furthermore, certain terminology has been used for the purposes of descriptive clarity, and not to limit the present invention. Therefore, any appended claims should not be limited to the description of the preferred versions contained herein and should include all such alterations, permutations, and equivalents as fall within the true spirit and scope of the present invention.

Having now fully described this invention, it will be understood to those of ordinary skill in the art that the methods of the present invention can be carried out with a wide and equivalent range of conditions, formulations, and other parameters without departing from the scope of the invention or any Examples thereof.

All patents and publications cited herein are hereby fully incorporated by reference in their entirety. The citation of any publication is for its disclosure prior to the filing date and should not be construed as an admission that such publication is prior art or that the present invention is not entitled to antedate such publication by virtue of prior invention.

What is claimed is:

1. A method of determining a manufacturing condition of a polythiourethane eyeglass lens obtained via a process of obtaining polythiourethane by polymerization reaction of an iso(thio)cyanate compound and a thiol compound, which comprises:
determining a candidate composition for a starting material mixture and a candidate polymerization reaction condition employed in the polymerization reaction in actual manufacturing;
polymerizing the starting material mixture of the candidate composition that has been determined under the candidate polymerization reaction condition to obtain a test sample;
testing the obtained test sample by irradiation with a xenon lamp to determine whether or not change into red-like color is present following irradiation with the xenon lamp; and
determining a starting material mixture composition and a polymerization reaction condition to be employed in the polymerization reaction in actual manufacturing with the use of a result of the determination as an indicator.

2. The method of determining a manufacturing condition according to claim 1, wherein
the starting material mixture composition and the polymerization reaction condition of a test sample that has been determined not to change into red-like color in the test are determined as a manufacturing condition in actual manufacturing; or
a starting material mixture composition and a polymerization reaction condition to be employed in the polymerization reaction are determined based on the starting material mixture composition and the polymerization reaction condition of a test sample that has been determined to change or not to change into red-like color in the test.

3. The method of determining a manufacturing condition according to claim 2, wherein a composition in which a blending ratio of a thiol compound relative to an iso(thio)cyanate compound has been increased or a composition in which a blending ratio of an iso(thio)cyanate compound relative to a thiol compound has been reduced in the starting material mixture composition of a test sample that has been determined to change into red-like color in the test is determined as the starting material mixture composition to be employed in the polymerization reaction.

4. A method of manufacturing a polythiourethane eyeglass lens, which comprises:
determining a manufacturing condition by the method according to claim 1; and
polymerizing polythiourethane under the manufacturing condition that has been determined.

5. A method of manufacturing a polythiourethane eyeglass lens, which comprises:
determining a manufacturing condition by the method according to claim 2; and
polymerizing polythiourethane under the manufacturing condition that has been determined.

6. A method of manufacturing a polythiourethane eyeglass lens, which comprises:
determining a manufacturing condition by the method according to claim 3; and
polymerizing polythiourethane under the manufacturing condition that has been determined.
